(19) United States
(12) Patent Application Publication
(10) Pub. No.: US 2005/0282140 A1
(43) Pub. Date: Dec. 22, 2005

(54) Process of relaying a story having a unique plot

(76) Inventor: Andrew F. Knight, Vienna, VA (US)

Correspondence Address: ANDREW F. KNIGHT, 2770 AIRLINE GOLDMINE RD., CANON, GA, 30520, US

(21) Appl. No.: 10/869,082

(22) Filed: Jun. 17, 2004

(51) Int. Cl. G09B 25/00

(52) U.S. Cl. 434/365

(57) ABSTRACT

A process of relaying a story having a timeline and a unique plot involving characters includes indicating that a first character experiences déjà vu to mask an actual event. The actual event would, absent déjà vu, cause the first character substantial emotional trauma or be a reminder of a past traumatic experience. The process may also include indicating that a second character exploits the first character's déjà vu to commit a crime on the first character or frame the first character in a commission of a crime.

A portion or all of the disclosure of this patent document contains material which is subject to copyright protection. The copyright owner has no objection to the facsimile reproduction by anyone of the patent document or the patent disclosure, as it appears in the Patent and Trademark office patent file or records, but otherwise reserves all copyright rights whatsoever.

### BACKGROUND OF THE INVENTION

Hollywood has been failing. Hackneyed plots are commonplace in modern movies and creativity has been replaced by expensive “special effects.” Elaborate explosions and sophisticated fight scenes bore even the slightest intellect where the storyline is confused, dull, or lacking. There is a substantial need for original, intellectually exciting plots in all forms of entertainment, such as novels and, particularly, motion pictures.

Traditionally, patent protection has provided the economic and moral impetus for technological improvements in all fields. An inventor is motivated to absorb the substantial financial, time, and personal costs of identifying problems with current technologies and inventing solutions to those problems when he is assured the right to exploit that invention by excluding others from making, using, selling, offering to sell, and importing his invention. 35 U.S.C. §271. Where patent protection is not available or is not easily obtained or enforced, such as in the typically statist welfare countries of Central and South America and communist countries such as China, technological progress is stunted by at least two causes: a) inventors employed by a company have little motivation to disclose their inventions to the public, and thus tend to keep their inventions as trade secrets within the company; and b) independent inventors have virtually no motivation whatsoever to disclose their inventions to anyone, because of (justifiable) fears of expropriation.

In much the same way, the progress of intelligent fictional plots, particularly of movies, has been stunted worldwide. Currently, a writer may receive free, comprehensive, and automatic copyright protection on anything she writes. If her skill consists primarily of expressing old, stale concepts in new, creative, exciting ways, then she will benefit from copyright protection. However, if her skill consists primarily of inventing new and unique broad concepts, then copyright protection will only protect one of uncountably many possible expressions of those new and unique concepts. This dangerous dichotomy is explained further.

Patents and copyrights aim to protect different interests. A copyrighted work is a particular expression or embodiment of a broader concept. For example, a broad concept might be, “Life is worth living for its own sake, and the only economic system that respects humans' right to live freely for their own happiness, without brute force compulsion to be sacrificed for the benefit of others, is capitalism.” A particularly beautiful expression of this broad concept is Ayn Rand's Atlas Shrugged, which is subject to copyright protection. Ayn Rand's estate does not own all embodiments of the broad concept—only the single expression embodied by her novel.

In sharp contrast, a patented invention protects each and every possible embodiment of a broad invention. Consider a patent on a car. It is not a particular actual car that is the subject of a patent, rather the wide class of possible cars that fall within the scope of the patent. In other words, a particular car is simply one protected embodiment of the broader patented invention. Because of the broad scope of rights afforded to a patent owner, one may not receive a patent on an invention that is old or obvious. 35 U.S.C. §§102-103.

Thus, patent protection and copyright protection differ substantially on the ease with which infringement may be avoided. Because a patent protects all expressions or embodiments of the single broad invention, a competitor who desires to use or sell the invention without paying royalties may not; it may only avoid patent infringement by paying royalties or avoiding the invention altogether. In sharp contrast, a competitor who desires to use the broad concept disclosed in another's work (e.g., book or article) may freely do so without infringing any copyrights, even when the broad concept is new and nonobvious. All the competitor must do is to create a moderately different expression of the broad concept.

It is clear that copyrights protect those who are good performers: those who sing well, dance well, write well, act well, and so forth. Copyrights are based on a system of recognition in which society rewards performers because they express an old concept in an original (and hopefully desirable) way, not because they express a new concept. Of course, many artists do invent original concepts, but it is their expression of those concepts, not their creation or invention of those concepts, that copyright protection rewards.

For example, one who sings a touching version of “White Christmas” may receive copyright protection on his performance—not because he invented the concept of singing about Christmas—not because he wrote the lyrics to the song—but because his particular vocal expression of it is original. Further, a woman who writes and performs a love song may receive copyright protection on both the lyrics and her performance—not because she invented the concept of singing about love—but because her particular written expression of love, and her particular vocal expression of those written lyrics, are original. Finally, consider the man who invents an entirely new and nonobvious type of music or method of performing music. Clearly, copyright law cannot protect his invention. His only possible recourse—which, to date, has not been tapped for the field of artistic inventions, such as original movie plots and new types of artistic expression—is patent protection.

There is no reason—neither statute nor case law nor PTO practice—why artistic inventions are not patentable subject matter under 35 U.S.C. §101. In the landmark decision Diamond v. Chakrabarty (447 U.S. 303, 1980), the Supreme Court held that living creatures were patentable subject matter under the doctrine that statutory subject matter includes “anything under the sun that is made by man,” with three exceptions: laws of nature, physical phenomena, and abstract ideas. According to the Manual of Patent Examining Procedure, these three exceptions recognize that subject matter that is not a practical application or use of an idea, a law of nature, or a natural phenomenon is not patentable. §2106 (IV)(A).

Certainly a movie implementing a unique plot is a practical application or use of the unique plot, so the unique plot should not be barred patentability under § 101. The invention of a new plot is just that—an invention—not merely an expression of an existing concept. Similarly, the practical application or use of any new artistic invention should be patentable subject matter.

The fact that each particular expression (e.g., a movie) of a broad artistic invention (e.g., an original plot) is subject to copyright protection is not unique to artistic inventions. For example, the software code on a patented software-containing disk may also be copyrighted. The defining criterion separating the subject matter of patents from copyrights is not whether the subject matter is related to art—see the amusing counterexample of U.S. Pat. No. 6,213,778 to Cohen. Rather, the defining criterion is whether the subject matter is a broad concept practically applied or used (in which case a patent is appropriate), or a particular instance, embodiment, expression, or performance of the broad concept (in which case a copyright is appropriate).

There is little fear that artistic creation will be halted due to the enforcement of patent protection newly applied to artistic inventions. A love song composer may indefinitely continue writing love songs without worry of infringing any patent, because the concept of writing songs about love is old and not patentable. Statute clearly requires an invention to be new and nonobvious to receive patent coverage. Thus, even if the broad concept or invention of singing about love were statutory subject matter under § 101, it is as old as civilization, and would not survive an attack under §§ 102-103. In fact, most artistic concepts today are very old—which is precisely the problem that must be remedied by patent protection for artistic inventions. Unless patents on artistic inventions are upheld and enforceable, the great artistic minds of the day will be compelled to continue composing predictable love songs for pop stars and slightly altered dialogues for carbon copied movie plots.

There is currently little motivation for artistic inventors to innovate new plots, themes, and methods of expression. The value of an innovator's copyright, if he in fact embodies his invention in a particular expression (such as a novel or movie) is far less than the value of the invention itself, because the invention umbrellas every possible embodiment. Further, and perhaps more importantly, the value of his copyright depends on his ability as a performer, not as an inventor. An artistic inventor who invents a fantastically original and compelling storyline may not be a particularly skilled writer. He may, for example, have a very limited vocabulary and a poor understanding of grammar. Any book he creates will be avoided by any potential buyer who reads the first paragraph, such that the copyright value of his extremely valuable invention is nil. Any Hollywood producer who sees through the book's garbled sentence structure to the excellent and creative plot beneath the surface may steal the only value the book contained: its inventive plot. The producer may then moderately alter the expression of the plot in a subsequent movie—while keeping the plot's essence fully intact—and obtain unearned financial benefit from the inventor's unrewarded hard work and innovation. If there is any evil that the United States patent system ought to prevent, it is this.

Said another way: the value of a singer's performance or a dancer's performance or a writer's performance or an artist's performance is in the performance, while the value of an inventor's invention is in the invention, not a single instance, embodiment, expression, or performance of the invention. The value of a performance is protected by copyright; the value of an invention is not. An artistic innovator is given but two choices absent patent protection: to sacrificially innovate for the unearned benefit of thieves, or to not innovate. Both options are morally and practically repulsive.

A patent system that sanctions and defends patents on artistic inventions, such as new and nonobvious plots, will spur an array of never-seen-before, never-experienced-before, intellectually inspiring forms of entertainment. A patent system that lethargically clings to an as-of-yet unarticulated rule that artistic inventions are not patentable subject matter because they are not closely enough related to a mechanical gear or an electronic integrated circuit will guarantee our nation the same repertoire of mind numbing movies and dime-a-dozen boy bands.

### SUMMARY OF THE INVENTION

The present invention aims to solve one or more of these and other problems.

According to one embodiment, a process of relaying a story having a timeline and a unique plot involving characters comprises: indicating that a first character experiences déjà vu to mask an actual event.

According to one embodiment, the present invention includes an information storage medium containing information of a story having a timeline and a unique plot involving characters, the information comprising: an indication that a first character experiences déjà vu to mask an actual event; and an indication that the actual event would, absent the déjà vu, at least one of the following: cause the first character substantial emotional trauma; and be a reminder of a past traumatic experience of the first character.

According to one embodiment, the present invention includes a program product for relaying a story having a timeline and a unique plot involving characters, the product comprising machine-readable program code for causing, when executed, a machine to perform the following process steps: indicating that a first character experiences déjà vu to mask an actual event; and indicating that the actual event would, absent the déjà vu, at least one of the following: cause the first character substantial emotional trauma; and be a reminder of a past traumatic experience of the first character.

### DETAILED DESCRIPTION

The following described plot may be applied to any form of entertainment, including motion pictures (movies), books, plays, television movies or episodes, radio shows, and may further be applied to any form of media, including video, audio, or written commercial advertisements, video, audio, or written news, etc.

One embodiment of a plot or storyline according to the present invention will now be described. The title of a movie or story of the present invention may be “Déjà Vu.” The storyline may include an indication that déjà vu occurs to mask an actual event, which, absent said déjà vu, would cause a person substantial emotional trauma or would be a reminder of a past traumatic experience. The storyline may include an indication that déjà vu serves as an involuntary coping mechanism to help prevent a person from reliving a past traumatic experience. Thus, when people experience déjà vu, at least some of the times their experienced event does not correspond to the actual event—i.e., the experienced event was “invented” by their brains (either during or after occurrence of the event), based on a previously experienced event (thus explaining the feeling during déjà vu that one is repeating a previously experienced event) to fool the person into denying that the actual event occurred. Thus, déjà vu may occur for a person only when that person would, absent déjà vu, experience an event that reminds the person of, or causes the person to mentally relive, a past traumatic experience. The event which evokes a person's déjà vu need not be a traumatic event to witness per se, but may merely suggest or remind the person of a past traumatic event. The actual experience of déjà vu is involuntary/uncontrollable (i.e., déjà vu, as understood by one of ordinary skill in the art, does not include when one intentionally thinks or dreams of something else to avoid experiencing an actual event), even if one (after knowing about how déjà vu can be caused) intentionally causes it to happen. In other words, while it may be possible to invoke déjà vu to occur (as will be discussed later), in a preferred embodiment, one cannot control what one experiences once déjà vu has begun, or how long it lasts, and so forth.

The setting is preferably present day, in urban or suburban United States. The protagonist, whose name may be Mark, is preferably relatively young, such as in his early 30's, and may be a clinical psychologist by profession. He may have a girlfriend with whom he has lived for three years, and who very much desires to be married and have a family. However, Mark is not so eager to be married, and in fact has a strong aversion to a commitment to his girlfriend, not because he doesn't love her, but because a past traumatic event is causing Mark to be psychologically incapable of committing.

As an example, when Mark was young (such as 10 or 11), he and his mother were very close. One day, such as on Mother's Day, they decided to have a mother-son outing together, such as getting dressed up and going out to dinner. However, on her way home from work or from a store, his mother is shot to death in an alley robbery. As a result of this traumatic broken commitment by his mother, Mark is uncontrollably afraid of committing to another woman, for the unjustifiable fear that she will die or leave or fail to return his love. This is merely one example of a past traumatic event that affects Mark later in life. Of course, many such examples are well known in the art, and are within the scope of the present invention.

The above explanation or account may be given in the form of a flashback, or the movie may begin during this past scene, after which the setting updates to the present setting (preferably present day). To begin the audience's concept of déjà vu as used in the present storyline, Mark's girlfriend may occasionally bring up the issue of marriage and/or commitment, and Mark may appear a bit spaced-out and interrupt her with, “Weird . . . I just had déjà vu.” Of course, she may become annoyed by this and beg him to pay attention and consider her comments. In other words, he may experience déjà vu when she discusses marriage, because it is an event that, absent déjà vu, may remind him of his mother (and more particularly the traumatic event of her being murdered).

However, preferably neither Mark not many others know the truth about déjà vu. Mark has a variety of patients and clients in a private psychology business. He has a personal advisor, confidante, trainer, and friend named Dr. Avery, who, perhaps, was Mark's research advisor when Mark was in graduate school. Dr. Avery is well known in the field, but may not be particularly well respected, due to various of wacky ideas and theories regarding psychology. Mark visits or contacts Dr. Avery once a week or every other week, and their meetings and relationship are social, advisory, and educational.

Near the beginning of the storyline, Mark may be watching a television news program that indicates that a local murder occurred. A very wealthy man was apparently stabbed to death in an alley (or some other poorly populated area), leaving a multi-million-dollar life insurance policy to his widow. A woman (hereinafter “the suspect”), who had previously been fired (or laid off) as an employee of the man's company, had been arrested and was being charged with the crime, because she was found at the scene of the murder with bloody hands and a bloody knife in her purse. She never denied the charge, but only asserted that she didn't know what happened; she doesn't remember murdering him or witnessing anyone else murdering him; she only remembers experiencing déjà vu right before she noticed him lying on the street, dead, with someone's blood on her hands. She also asserts that she never had any motivation to harm him, as she didn't know him, and held no animosity toward him or the company for firing her. The news program also indicated that she had been involved in (and perhaps narrowly acquitted from a criminal trial against her, or perhaps had already served prison time for a conviction regarding) a similarly performed stabbing murder ten years ago. Mark watches the program with curiosity, but doesn't take any further interest.

Mark knows that his girlfriend witnessed a very traumatizing event when she was in middle school. She and her best friend at the time were playing near the edge of a cliff when her friend decided to walk play at the edge for the thrill of being a daredevil. Due to a couple of loose rocks, he lost his balance and fell to his death, an event that has haunted his girlfriend at various times throughout her life.

One day, she, Mark, and perhaps a mutual friend or two are driving across a bridge when they notice that several lanes are cut off due to a police car blockage. Upon closer inspection as they slowly inch forward through the bumper-to-bumper traffic, Mark and the friends notice a man standing on the edge of the bridge, surrounded by officers, news crews, and various others, who is shouting that he plans to commit suicide. A moment later, he jumps to his death, but Mark, who sees his girlfriend staring in the direction of the man who just jumped, is less concerned about witnessing a suicide than he is about his girlfriend's reaction to watching a man fall to his death. Mark glances in the back seat at their mutual friends and, via facial expressions, they communicate their realizations of the magnitude of the turmoil that Mark's girlfriend just experienced and will continue to experience for several weeks or months. Surprisingly to all, Mark's girlfriend simply turns his direction and states, unmoved and unemotionally, “Hmmm . . . déjà vu!” She doesn't mention it again for the rest of the day.

Mark may later test her, because he is, of course, amazed that she would not be emotionally affected by staring in the direction of a man who jumped to his death. For example, he may later state, “I wonder what all those police were on the bridge for today.” She may reply that she had no idea, and was wondering the same thing herself. Alternatively, they may be watching the evening news when a news article explains the commotion on the bridge today. In one embodiment, Mark's girlfriend may incredulously exclaim to Mark, “Did you know there was a suicide jumper on the bridge today?” In another embodiment, the news article includes video footage of the shouts and pleas of the jumper and, in the background, Mark's car may be seen driving past. At this, Mark's girlfriend's eyes widen as she realizes that she was a firsthand witness to the event, but didn't even notice it. In another embodiment, she says “déjà vu” during the news article and does not seem to take notice of its content.

The next day, Mark shows up at Dr. Avery's office and explains to him what he observed. Of course, Mark is emotionally distraught by the observation of his girlfriend, believing that perhaps there is something psychologically wrong with her, or believing that there are magical, evil forces at work. Dr. Avery swears up and down that he does not know how or why Mark's girlfriend failed to notice the emotionally taxing event. However, Mark insists that Dr. Avery is among the best in the field, and has consistent (albeit often unconventional) solutions and explanations for problems that other psychologists only ponder. Mark begs Dr. Avery for help, realizing that it is a problem he can't face himself. Finally, Dr. Avery tells Mark to sit down, and he explains what he knows about déjà vu, particularly that description previously given above. For example, he explains that the mind may induce déjà vu by, perhaps, re-experiencing (i.e., “copying and pasting”) the same sensations that a person just experienced, or perhaps experienced previously in the day, the year, or life in general. The mind may do so during or retroactively after an event which would, absent déjà vu, be very emotional taxing on a person, and/or be a reminder of a past traumatic event or experience.

Dr. Avery, who knows about Mark's past, explains how his past traumatic experience (of his mother being shot to death) could (but need not necessarily) cause Mark to experience déjà vu when any actual event occurs that might remind Mark of cause Mark to relive the past traumatic experience. Examples of such actual events may include, but are not limited to: hearing a loud bang that sounds like a gunshot; seeing a photo of his mother; seeing a series of Mother's Day cards at a drug store; Mark's girlfriend asking him to commit; seeing someone get shot in a fictional movie; and so forth. Dr. Avery explains that the more the actual event emulates the past traumatic experience, the more likely Mark will experience déjà vu during that actual event. Thus, he explains, it is almost certain that Mark would experience déjà vu in the unlikely event that Mark should ever witness a person being shot in real life. Before Mark leaves his office, Dr. Avery requests that Mark keep this advice to himself, as he asserts that he is concerned about his own reputation and does not want to further the industry's poor perception of his non-conventional ideas. Dr. Avery also indicates that few others (if any) know about his theory of déjà vu. Mark understands and leaves.

Mark attempts to learn more about and test Dr. Avery's theory about déjà vu. For example, he may know about one or more past traumatic experience for each of his patients, and may attempt to arouse those memories with various words, objects, pictures, actions, and so forth, and ask them if and when they experienced déjà vu. He may do the same sort of experiments on himself and his girlfriend, with or without his girlfriend's knowledge. For example, he may take her for a walk on a steep hill, and pretend to accidentally slip, and subsequently ask her to see if she experienced déjà vu.

Later, Mark is again watching a television news program when a news clip updates him on the progress of the aforementioned murder case. A short video clip is shown of the suspect during her arrest during which she incoherently shouts phrases regarding her lack of memory, her confusion, her lack of a motive, and, most importantly, her déjà vu experience while the murder occurred. At this point, Mark is inspired, energized, and fearful by the realization that the suspect may not have committed the crime, and may have been a witness as someone else committed the crime. The suspect may then have involuntarily experienced déjà vu to mask the actual murder event. He immediately calls Dr. Avery, who does not pick up her phone, and leaves a hurried, excited, concerned message on Dr. Avery's voicemail regarding the suspect.

Without further consideration, Mark immediately begins a several-day investigative quest in which he attempts to find out more information about the suspect. Eventually, through one or more means or method known in the art for portraying a character successfully investigation a question, Mark may come to several conclusions. (The various ways and creative methods in which a character in a story may successfully investigate a question, such as a question regarding another character, are well known in the art and within the scope of the present invention, and will not be discussed further here.) First, he may come to learn or believe that the suspect was never a perpetrator in the previously mentioned stabbing murder (the one occurring ten years prior, such as to a parent, sibling, or loved one); rather, she was an involuntary witness. The event was so gruesome and nauseating and traumatic that it became an event to which she would in the future experience déjà vu upon its reminder or recollection. Second, he may come to learn or believe that the rich, murdered man's widow began seeing a much younger man soon after his murder, and that she was, quite happily, the sole beneficiary of a multi-million-dollar life insurance policy.

Mark soon puts the pieces together. The suspect did not murder the man, nor had anything to do with the man. The widow, either herself or through an agent, murdered the man to collect the life insurance policy. More importantly, the man was openly murdered, by stabbing, with the suspect as the only witness. Why? The perpetrator must have known the truth about the suspect—namely, that she wasn't a murderer, but was an involuntary witness to a previous traumatizing stabbing murder, who would experience déjà vu if she ever witnessed something similar, and would not “snap out” of the déjà vu experience until after the event was mostly or completely over. The perpetrator knew that she would not remember the murder event, and thus would not be able to deny it, and further that it would be easy to toss the man's blood on her hands and toss the bloody knife in her purse while she remained in a déjà vu “reality avoidance” daze. The perpetrator also knew that her previous arrest and/or conviction for the prior stabbing murder, and/or her being laid off or fired from the man's company, would provide a motive and explanation for the murder. Further, it might be easy to convince a jury that she was just reliving the rage in her past “murder” (even if she didn't actually commit that past murder) when she decided to brutally murder the wealthy man.

The suspect was framed. Why? An open, ongoing murder investigation might cause hell for the widow, and may ultimately lead to her arrest. By quickly and efficiently pinning the murder to the suspect, the local authorities will rest easy that they have captured the murderer, and the investigative portion of the case will rapidly come to a close. It is well known that crime victims and law enforcement authorities are usually quite content to have someone (anyone) to blame—whether or not there is sufficient reason to believe that that someone is the perpetrator.

Once Mark realizes this, he thinks back to his conversation with Dr. Avery, and realizes that Dr. Avery or one of his students may be involved, because (by his own account) few other than Dr. Avery know the true nature of déjà vu. Soon thereafter, Dr. Avery unannounced shows up at Mark's home or office, to briefly discuss the case of the suspect. Dr. Avery, at this point, acts very suspiciously, and advises Mark to leave the case alone. He may provide one or more of many reasons or justifications for dropping the case, such as that the whole déjà vu theory might hurt her case because it is so unbelievable, or perhaps Dr. Avery (asserts that he) himself has investigated the case and convinced himself that the suspect was the perpetrator, and so forth. Mark, who now realizes that Dr. Avery is lying and was involved in the murder, tries his best to appear cooperative and obedient. He fails. Mark's facial expressions clearly indicate fear, suspicion, and lack of trust. Without explicitly admitting to the crime, Dr. Avery explains some or all of what Mark believes about the murder. For example, he may say, “You must think that the suspect was framed by the man's wife. You must think the murderer knew of the suspect's propensity for experiencing déjà vu during a stabbing murder, and thus wouldn't remember who did it, and whether or not she did it. You must think that the suspect will serve time for a crime she didn't commit and one that made the widow very wealthy. I guess anyone could be framed in a similar way. You should be careful.”

At this, Dr. Avery walks away, the implication clear that he intended to threaten Mark. Mark quickly calls his girlfriend and tells her to go home to her parents (such as in another city) until further notice. In the meantime, Mark realizes that Dr. Avery intends to target and frame Mark in much the same way as the suspect. The plan would be perfect. Already, the déjà vu defense was shaky and weak when provided by an independent, uninvolved psychologist on behalf of the suspect; it is that much weaker and unbelievable when provided by a murder suspect himself. If Mark were framed, he would almost surely be convicted and sent to prison or committed to a mental hospital, where he would remain out of Dr. Avery's hair and allow him to continue helping others—presumably for profit—commit various crimes.

Reflecting on his past conversation with Dr. Avery, Mark knew that he would experience déjà vu were he to witness someone being shot to death. He realized that the only way to prevent déjà vu based on this past traumatic experience is to directly confront its trauma. If he no longer fears or abhors the memory, then Mark's brain won't attempt to mask the memory or its reminder by playing the déjà vu game on itself. Thus, in the next few very sad, very emotionally touching scenes, Mark does his best to remember and relive his mother's memory, particularly the night she was killed. He realizes that he never came to terms with her loss—he never properly dealt with her loss—and thus déjà vu was always readily available to protect him from having to ever deal with the loss. Until now. In a self-induced dream, he relived some of his fondest memories of his mother, taking note of what he loved about her and what he didn't love about her. He recalled the laughter, the tears, the struggles, the achievements, the wounds, the healing, the anger, and the love. Then, he relived the moment (e.g., on Mother's Day when he was 10 or 11) when he made plans with her. He then altered the dream some, telling his mother that if she doesn't come home, that he loves her and will always cherish their memory. Later that night during his self-induced dream, after his mother is shot, she again appears before him. He tells her how much he loves her, how much he will miss her, and that he will always remember her. He acknowledges that he will not see her again, but that she will always be with him. She reminds him, with her typically good motherly advice, that life is about living. Living sometimes comes with gains, and sometimes with losses, and if we are to accept the gains, we must accept the losses and move on. With that, he embraces her and tells her goodbye. He woke up and cried himself to sleep. He had finally confronted his past and let go of his demons.

Mark remained on his guard the next few days, realizing that Dr. Avery would try to eliminate him very soon by framing him in the commission of a crime. He purchased a handgun and carried it with him. One evening, when he came from work, he walked into his apartment to find Dr. Avery holding a gun to his girlfriend's head. “I can't believe you're going to kill your own girlfriend in your own apartment,” he evilly chuckled. “You're going to prison, Mark. Maybe you'll get the chair. Psychology is amazing, isn't it? You won't even remember what happened.” A fire is shot, and using good cinematography, it will not be initially clear to the audience who has been shot, although the suggestion is that Mark's girlfriend has been shot. Next, Mark is shown holding a smoking gun, and he says, “No, you won't,” he says to Dr. Avery's fallen body. Of course, Mark's girlfriend has been saved by Mark, who was cognizant, aware, and armed during Dr. Avery's performance. Mark did not experience déjà vu at a time he would have ordinarily experienced déjà vu, because he confronted the trauma of his mother's death.

Because Mark has confronted this trauma, he feels emotionally free and released from the bonds of a noncommittal persona. The movie may end where he proposes to his girlfriend, or they are married, or have a family, and so forth.

Variations on the present plot are within the scope of the present invention. For example, Dr. Avery (who may work by himself or with others or via other agents, or perhaps Dr. Avery is not involved at all) may profit (monetarily, for belief, for favors, for resentment or envy, and so forth) by framing others (by use of their déjà vu) in the commission of crimes, or by actually committing the crimes on those others. Other crimes are within the scope of the present invention, and include any crime presently known. For example, the perpetrator may rob a bank in the presence of someone who previously witnessed (and was traumatized by) a bank robbery, and then abduct that person and plant him near the bank with a portion of the robbed cash to thereby frame him in the robbery. As another example, a person whose brother or sister was kidnapped at a young age may experience déjà vu under similar circumstances. Dr. Avery may then relatively easily kidnap the person's child in the person's presence. The person will not know what happened, and will simply assume that she lost her child.

Of course, any of the above mentioned past traumatic events may be replaced by any known event that may be believably traumatizing to a person, such as the kidnapping or abduction of a loved one, the death or murder of a loved one, being raped, molested, or abused, one's father cheating on one's mother, a divorce, a loved one who acts self-destructively (e.g., an alcoholic parent), and so forth.

The above storyline need not include a “bad guy,” such as Dr. Avery, at all, although this may make the plot more interesting. For example, Mark could simply discover on his own the true nature of déjà vu, and as a result, use this information to help exonerate a person charged with a crime, particularly where the crime was actually an accident or was the fault of the victim. For example, a friend commits suicide in the person's presence by jumping off a cliff. Because the person had déjà vu, she cannot convince a jury or a polygraph that she didn't push her friend from the cliff. The “evil” in such a plot may be people's ignorance of the true nature of déjà vu and the difficulty of introducing the déjà vu theory into evidence before a verdict is returned.

In another embodiment, déjà vu may result when the actual event would, absent déjà vu, cause a person substantial emotional trauma, even if the trauma is not related to or a reminder of a past traumatic event. For example, instead of the present storyline being a suspense thriller, it may be more along the lines of a horror film. For example, Dr. Avery may be a quantum physicist and professor at a large university, who teaches Mark that quantum mechanics only assigns probabilities to the measurements of various events, but does not restrict the kinds of events that may occur, recognizing that some events are very unlikely. For example, Mark may suggest the idea of pigs flying, and Dr. Avery may reply that such an event is not only possible, but it is expected to occur with a particular (very low) probability. If that's true, reasons Mark, then even though each wacky, possible event has a very low probability, there are so many possible wacky events that one or more should be occurring at any given time. Dr. Avery agrees. “So why don't we experience any of them?” “Sometimes we do,” retorts Dr. Avery, “but usually we dismiss them as being illusions or apparitions, as we simply shrug them off. Other times, when the evidence is unmistakable and we can't blame the experience on an illusion, our brains simply can't cope or deal with or believe such an event, and we experience déjà vu.” Armed with this new knowledge—the understanding that not only is anything possible, but that seemingly impossible or unlikely events happen before our very eyes quite often—Mark's mental defenses drop and he begins to truly “open his eyes.” He stops experiencing déjà vu at times in which he would ordinarily (i.e., before learning the true nature of déjà vu from Dr. Avery) experience déjà vu.

He may see lots of crazy and/or unusual things, such as aliens, monsters, flying pigs, talking squirrels, and so forth. He may also notice unusual or seemingly possible events, such as water falling upward, someone “unscrambling” an egg, and so forth. He realizes that when small children see things, such as monsters under their beds, they are right; it is the blind adults whose brains choose to ignore the evidence of such monsters that ultimately convince the children that their senses fool them. He also understands now why dogs often apparently bark at “nothing.” Dogs can see what humans can't, because dogs don't have the déjà vu mental defense (or coping) mechanism to mask an actual event that may otherwise cause substantial emotional trauma. He realizes that this may also explain various unexplained events, such as murders. For example, a person may be killed by some kind of monster that no one can see, because their experience or evidence of the monster is erased by a mind-caused déjà vu experience. In other words, in this and some other embodiments, the human mind is regularly in a state of denial for the person's own emotional protection or health, and déjà vu helps to maintain that denial against the most conspicuous evidence to the contrary. In this case, seeing the “truth” about the world—including all of the strange, wacky events—may be substantially emotionally traumatic to a common person, but not so much so for Mark, who may have been emotionally prepared for the truth by his quantum physicist professor.

In another embodiment, the protagonist may, until some point in the movie or storyline, have never experienced déjà vu, even though he knows that others have experienced it, and may even know about its true nature. However, perhaps he had only one very traumatic past experience. In a very sad moment in the movie, he finally experiences déjà vu for the first time. For example, perhaps his brother was hit and killed by a car when he was very young. The protagonist's son, who looks much like the protagonist's deceased brother, is one day playing in the street, when the protagonist shouts for the child to get out of the street, when he experiences déjà vu, and his son is killed or at least hurt. Perhaps this is the sad event that causes the protagonist to want to learn more about déjà vu, or to help others to overcome and confront the trauma of their past traumatic experiences.

In another embodiment, in addition or alternatively to the knowledge of the truth about déjà vu being used to exonerate a crime suspect, or to defeat a “bad guy” attempting to exploit others' déjà vu in crimes against them or framing them in committed crimes, déjà vu may also be used to solve a crime. For example, a woman is the only witness to a crime, but she swears that she does not recall anything. When pressed, she finally recalls that she experienced déjà vu at some point when the crime was being committed. When she spends time with a psychologist (e.g., Mark), a deep-rooted fear or traumatic memory or event is finally unearthed, and somehow it solves the crime. For example, perhaps only one of several possible scenarios and/or crime suspects would have triggered her fear and resulting déjà vu. For example, perhaps her father owned a particular make and model of automobile (which she associated with him) when he died in an automobile accident when she was very young. She realizes this one day, when she has déjà vu and, about the same time, her friend or husband starts talking about a car on the street (which they both just saw) that is identical to her father's old car. She then realizes that this is what causes her to have déjà vu, and returns to the police station to explain the fact. Incidentally, one of the suspects drives the identical make and model automobile, which solves the crime. Other examples of how a crime may be solved in such a manner, or information obtained from a witness who does not recall witnessing an event due to déjà vu, will be apparent to one of ordinary skill in the art, and are within the scope of the present invention.

In another embodiment, near the end of the storyline, Mark may call the police or take pictures via a hidden camera of Dr. Avery instead of shooting Dr. Avery with a gun. For example, if Mark knows or suspects when and where Dr. Avery will attempt to frame him, Mark may have the police ready to arrest Dr. Avery. Some audiences hate the idea of the bad guy being killed, no matter how evil he is or how many people he has brutally slaughtered, and would prefer that the bad guy be arrested and go to jail.

In another embodiment, Mark's girlfriend may be replaced or supplemented by another loved one, such as one whom he fails to commit to, such as a young son by a previous marriage whom Mark has not made a strong effort to see or support or “be a dad” for, at least in part because of his committing problems due to his mother's death. In another embodiment, Mark may know the suspect, and/or the suspect may be a friend or loved one. Further, Mark's advisor and confidante (e.g., Dr. Avery) may be different from the person or people who implement the previously discussed method of exploiting people's déjà vu for commission of crimes and/or framing. Other ways that Mark may discover or learn the truth about déjà vu, or learn that he, his girlfriend, and/or the suspect experience déjà vu to mask actual events, that are apparent to one or ordinary skill in the art are within the scope of the present invention.

In a preferred embodiment, several features are indicated, such as indicating that Mark, his girlfriend, and/or the suspect experience déjà vu to mask actual events. As well known by those of ordinary skill in the art, there are many ways to indicate a fact in a movie or a book without any explicit words to that effect at all: circumstance, cinematography, subtly suggestive newspaper headlines, suggestive words by the protagonist or other characters, etc., can all be indicative of that fact.

The story preferably has a timeline, which will be well understood by one of ordinary skill in the art. For example, in a story containing flashbacks, the timeline may represent the chronological order in which events occur in the story. Therefore, a flashback may occur earlier in the story's timeline, even though the flashback is presented in a later part of the story.

The present invention applies to any practical application or use of the present plot. For example, the invention includes the processes of relaying a story having the present plot, writing a book having the present plot, printing a book having the present plot, creating a movie having the present plot, displaying or showing a movie having the present plot, filming a movie having the present plot, inciting actors to act out the present plot, creating an audio recording of a story having the present plot, etc. The present invention also applies to any product of any of these processes—e.g., a book containing written information of a story having the present plot, an audio tape or CD disk containing audio information of a story having the present plot, a VHS tape or DVD or VCD disk containing video information of a movie having the present plot, etc.

For example, creating a movie having the present plot may include inciting an actor to act as the protagonist. As will be understood by one of ordinary skill in the art, a producer or director or production company may incite an actor to act as the protagonist by promising a financial or a career-related reward or advancement. Creating such a movie may also include providing a set, as known by those of ordinary skill in the art, video cameras (preferably high-resolution digital video cameras), and editing equipment, and using the set, cameras, and equipment to create video segments of footage of the actors acting consistent with the present plot. The final video may be stored on an information storage medium, duplicated onto VHS tapes or DVDs, and distributed and sold.

Regarding a program product that comprises machine-readable program code for causing, when executed, a machine to perform process steps, the machine could be a VCR or DVD player or similar, and the code could comprise the instructions and/or data which, when read by the VCR or DVD player, causes the VCR or DVD player to perform the indicated process steps, whether directly or indirectly via a monitor (e.g., television screen) and speakers.

The present invention may include one or more of the steps discussed, as well as the causing or inciting or encouraging of another to perform one or more of the steps. For example, if a method comprising steps A, B, and C is used according to one embodiment of the present invention, then a method comprising performing or inciting another to perform one or more of steps A, B, and C, where A, B, and C are performed, includes the following scenarios as examples: a person performs A, B, and C; a person encourages another to perform steps A, B, and C; a person performs steps A and B and encourages another to perform step C; a person performs step A, pays a first person to perform step B, and causes a second person to perform step C; and so forth.

1. A process of relaying a story having a timeline and a unique plot involving characters, comprising:
indicating that a first character experiences déjà vu to mask an actual event.

2. The process as claimed in claim 1, further comprising indicating that said actual event would, absent said déjà vu, cause said first character substantial emotional trauma.

3. The process as claimed in claim 2, further comprising indicating that said first character does not experience déjà vu at times in which said first character would ordinarily experience déjà vu.

4. The process as claimed in claim 1, further comprising indicating that said first character had a past traumatic experience.

5. The process as claimed in claim 1, further comprising indicating that said actual event would, absent said déjà vu, be a reminder of a past traumatic experience of said first character.

6. The process as claimed in claim 1, further comprising indicating that said déjà vu serves as an involuntary coping mechanism to help prevent said first character from reliving a past traumatic experience.

7. The process as claimed in claim 1, further comprising indicating that a second character exploits said first character's déjà vu to at least one of commit a crime on said first character and frame said first character in a commission of a crime.

8. The process as claimed in claim 1, further comprising:
indicating that a third character discovers that said first character experiences déjà vu to mask actual events that would, absent said déjà vu, at least one of the following:
cause said first character substantial emotional trauma; and be reminders of a past traumatic experience of said first character; and
indicating that an identification of said past traumatic experience contributes to solving a crime.

9. The process as claimed in claim 1, further comprising indicating that a third character discovers that said first character experiences déjà vu to mask actual events.

10. The process as claimed in claim 9, further comprising:
indicating that said third character experiences déjà vu to mask an actual event that would, absent said third character's déjà vu, at least one of the following: cause said third character substantial emotional trauma; and be a reminder of a past traumatic experience of said third character; and
indicating that said third character discovers that said third character experiences déjà vu to mask actual events.

11. The process as claimed in claim 10, further comprising indicating that a second character intends to exploit said third character's déjà vu to at least one of commit a crime on said third character and frame said third character in a commission of a crime.

12. The process as claimed in claim 10, further comprising:
indicating that said third character confronts a trauma of said third character's past traumatic experience.

13. The process as claimed in claim 12, further comprising:
indicating that, after said character confronts said trauma, said third character does not experience déjà vu to mask an actual event that would, absent said third character's déjà vu, be a reminder of said third character's past traumatic experience.

14. The process as claimed in claim 13, further comprising:
indicating that a second character intends to exploit said third character's déjà vu to at least one of commit a crime on said third character and frame said third character in a commission of a crime; and
indicating that said second character fails to exploit said third character's déjà vu at least in part because said third character has confronted said trauma.

15. The process as claimed in claim 12, further comprising:
indicating that said third character has failed to commit to a significant other; and
indicating that, after said character confronts said trauma, said third character commits to said significant other.

16. The process as claimed in claim 1, further comprising:
indicating that a first character had a past traumatic experience;
indicating that said first character experiences déjà vu to mask an actual event that would, absent said first character's déjà vu, at least one of the following: cause said first character substantial emotional trauma; and be a reminder of said past traumatic experience of said first character;
indicating that a third character discovers that said first character experiences déjà vu to mask actual events;
indicating that a third character had a past traumatic experience;
indicating that said third character experiences déjà vu to mask an actual event that would, absent said third character's déjà vu, at least one of the following: cause said third character substantial emotional trauma; and be a reminder of said past traumatic experience of said third character; and
indicating that said third character discovers that said third character experiences déjà vu to mask actual events.

17. The process as claimed in claim 16, indicating that a second character exploits said first character's déjà vu to at least one of commit a crime on said first character and frame said first character in a commission of a crime.

18. The process as claimed in claim 16, further comprising:
indicating that said third character confronts a trauma of said third character's past traumatic experience; and
indicating that, after said character confronts said trauma, said third character does not experience déjà vu to mask an actual event that would, absent said third character's déjà vu, be a reminder of said third character's past traumatic experience.

19. The process as claimed in claim 18, further comprising:
indicating that a second character intends to exploit said third character's déjà vu to at least one of commit a crime on said third character and frame said third character in a commission of a crime; and
indicating that said second character fails to exploit said third character's déjà vu at least in part because said third character has confronted said trauma.

20. The process as claimed in claim 1, further comprising:
indicating that said actual event would, absent said déjà vu, at least one of the following: cause said first character substantial emotional trauma; and be a reminder of a past traumatic experience of said first character,
wherein each of said steps of indicating comprises indicating in a written form.

21. The process as claimed in claim 1, further comprising:
indicating that said actual event would, absent said déjà vu, at least one of the following: cause said first character substantial emotional trauma; and be a reminder of a past traumatic experience of said first character,
wherein each of said steps of indicating comprises indicating in a video form.

22. The process as claimed in claim 1, wherein said process is a process of displaying a motion picture having a timeline and a unique plot, comprising:
displaying a video representation of an actor acting as said first character;
displaying a video representation of an indication that said first character experiences déjà vu to mask an actual event; and
displaying a video representation of an indication that said actual event would, absent said déjà vu, at least one of the following: cause said first character substantial emotional trauma; and be a reminder of a past traumatic experience of said first character.

23. The process as claimed in claim 1, wherein said process is a process of creating a motion picture having a timeline and a unique plot, comprising:
providing a set;
providing a video camera configured to video at least a portion of said set;
inciting a first actor to act as said first character;
inciting said first actor to indicate that said first character experiences déjà vu to mask an actual event;
creating a first video segment via said video camera by filming said indication by said first actor;
inciting a second actor to act as a third character;
inciting said second actor to indicate that said third character discovers that said first character experiences déjà vu to mask actual events;
creating a second video segment via a video camera by filming said indication by said second character;
editing and combining at least part of at least said first and second video segments to form a motion picture; and
storing said motion picture on an information storage medium.

24. An information storage medium containing information of a story having a timeline and a unique plot involving characters, said information comprising:
an indication that a first character experiences déjà vu to mask an actual event; and
an indication that said actual event would, absent said déjà vu, at least one of the following: cause said first character substantial emotional trauma; and be a reminder of a past traumatic experience of said first character.

25. A program product for relaying a story having a timeline and a unique plot involving characters, said product comprising machine-readable program code for causing, when executed, a machine to perform the following process steps:
indicating that a first character experiences déjà vu to mask an actual event; and
indicating that said actual event would, absent said déjà vu, at least one of the following: cause said first character substantial emotional trauma; and be a reminder of a past traumatic experience of said first character.
